(19) United States
(12) Patent Application Publication
(10) Pub. No.: US 2026/0169797 A1
(43) Pub. Date: Jun. 18, 2026

(54) DYNAMICALLY ADJUSTABLE RESOURCE USAGE SYSTEM

(71) Applicant: Snowflake Inc., Bozeman, MT (US)

(72) Inventors: Phillip Bryant, San Mateo, CA (US); Murray Marvin Stokely, III, Los Altos, CA (US)

(21) Appl. No.: 18/984,138

(22) Filed: Dec. 17, 2024

(51) Int. Cl. G06F 9/50

(52) U.S. Cl. CPC G06F 9/5005

(57) ABSTRACT

A system enables clients to utilize resources that have been committed from one or more third-party resource providers, allowing them to execute various operations on a data platform. The system tracks the aggregate historical use of these resources over a specific period and monitors any unused resources within a first term commitment over an initial time period. The system also tracks requests for additional resources representing times when demand exceeded the baseline commitment and required supplemental, short-term resources. This collected data is then fed into a predictive model. The model analyzes these inputs to generate a forecast of future resource needs, providing an informed view of anticipated demand for upcoming periods. Based on this forecast, the system executes a first term commitment for resources, securing the necessary capacity over a second time period in alignment with the forecasted usage, thus optimizing resource allocation and cost efficiency.

### TECHNICAL FIELD

Embodiments of the disclosure relate generally to system resources and, more specifically, to a dynamically adjustable resource usage system.

### BACKGROUND

Network-based database systems may be provided through a cloud data platform, which allows organizations, customers, and users to store, manage, and retrieve data from the cloud. With respect to this type of data processing, a cloud data platform could implement online transactional processing, online analytical processing, and/or another type of data processing. Moreover, a cloud data platform could be or include a relational database management system and/or one or more other types of database management systems.

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to types of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. Indeed, the data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment that includes a cloud data platform, according to some examples.

FIG. 2 is a block diagram illustrating components of a compute service manager of the cloud data platform, according to some examples.

FIG. 3 is a flow diagram illustrating an example method for dynamically adjusting term commitments for resources, according to some examples

FIG. 4 is a set of graphs illustrating the optimization process of resources, according to some examples.

FIG. 5 illustrates further optimization of resource usage according to some examples.

FIG. 6 illustrates training and use of a machine-learning program, according to some examples.

FIG. 7 illustrates a machine-learning pipeline, according to some examples.

FIG. 8 illustrates a diagrammatic representation of a machine in the form of a computer system within which a set of instructions may be executed for causing the machine to perform any one or more of the methodologies discussed herein, in accordance with some examples of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

In the present disclosure, physical units of data that are stored in a data platform—and that make up the content of, e.g., database tables in user accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, on, etc.) what is referred to herein as an “internal storage location.” If stored external to the data platform, a given file is referred to herein as an “external file” and is referred to as being stored in (or at, on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a user account. The data platform may include one or more databases that are respectively maintained in association with any number of user accounts (e.g., accounts of one or more data providers or other types of users), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular user accounts as well. Users and/or executing processes that are associated with a given user account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a user account) may reside as an object within, e.g., a user account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

A data platform (e.g., database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middles East, Asia, the Pacific, etc.), a specific version of a data platform, or a combination thereof. A user of an individual account can be unique to the account. Additionally, a data platform can use an organization data object to link accounts associated with (e.g., owned by) an organization, which can facilitate management of objects associated with the organization, account management, billing, replication, failover/failback, data sharing within the organization, and the like.

Traditional systems for managing cloud resources often rely on fixed, long-term commitments or on-demand resources without advanced forecasting or flexible adjustments to optimize costs and match fluctuating demand. These systems generally lack the ability to dynamically adapt resource allocation to changing usage patterns, leading to several key deficiencies:

Traditional systems typically make annual or multi-year commitments for cloud resources, aiming to secure lower costs through long-term contracts. However, these commitments are based on estimated or historical averages and often fail to account for seasonal or unexpected spikes and dips in demand. As a result, they may either over-commit, leading to excess, unused capacity during low-demand periods, or under-commit, causing a shortfall in resources when demand unexpectedly rises. Both scenarios result in inefficient resource use and increased costs.

When long-term commitments fall short of actual demand, traditional systems often turn to on-demand resources to fill the gap. While on-demand resources offer the flexibility to scale up quickly, they are significantly more expensive than long-term commitments. Relying on these resources to handle unanticipated demand spikes or peak usage periods can drastically increase operational costs, especially if this becomes a recurring solution.

Traditional systems generally lack robust forecasting tools to anticipate changes in resource needs. Without machine learning models or advanced analytics, such systems cannot accurately predict seasonal trends, industry-specific demand cycles, or even daily usage variations. This absence of predictive insights means traditional systems rely heavily on static planning, which leads to inefficient resource allocation and the inability to preemptively adjust for future demand.

Traditional systems often lack the capability to defer or precompute non-essential tasks based on forecasted resource demand. As a result, internal tasks like regression testing or data backup might run during peak periods, consuming resources that could otherwise serve immediate client needs. This inability to shift tasks to low-demand periods further amplifies inefficiencies and can exacerbate resource shortages during high-demand periods.

In summary, traditional systems struggle with the inflexibility of fixed commitments, high costs associated with on-demand resources, limited forecasting capabilities, and the absence of dynamic task scheduling, leading to suboptimal resource utilization and increased operational expenses.

Aspects of the present disclosure address the foregoing issues, among others, with a data platform, systems, methods, and devices that combines predictive modeling, dynamic resource allocation, and task scheduling optimization. By leveraging these advanced techniques, the data platform aligns resource commitments more closely with actual usage patterns, reduces costs, and maximizes efficiency.

Unlike traditional systems that rely on rigid long-term commitments, the data platform implements laddered commitments across various time frames (e.g., monthly, quarterly, annually, across multiples such as every three weeks or three years, multiple times a week, and/or the like). This staggered approach allows the data platform to adapt to changing demand without locking all resources into a single, inflexible commitment. By staggering commitment levels, the data platform can make frequent adjustments based on real-time insights and demand forecasts, ensuring that resources are scaled up or down as needed. This flexibility minimizes the risk of over-or under-commitment, improving cost efficiency and reducing unused capacity. In some cases, the data platform implements laddered commitments where long-term commitments are made at staggered start and end times (e.g., multiple different commitments made each time period such as each day).

The data platform uses a predictive model to anticipate periods of high and low demand based on historical data and forward-looking factors (e.g., product launches or system upgrades). This forecasting allows the system to proactively adjust baseline commitments to cover predictable demand spikes, thereby reducing dependency on expensive on-demand resources. When demand does exceed the committed capacity, the model identifies the minimum additional on-demand resources required to meet client needs, further optimizing costs. By carefully planning commitments based on predictive insights, the data platform maintains the right balance between flexibility and cost savings.

One feature of the data platform is its machine learning-driven predictive model, which uses historical usage data and non-historical factors (like upcoming events) to accurately forecast resource demand. This model continuously learns from patterns such as seasonal fluctuations, weekly cycles, or industry-specific spikes, enabling it to predict future demand with high accuracy. The model not only helps in setting initial commitment levels but also provides recommendations for dynamically adjusting them, ensuring that resource allocation aligns more closely with anticipated needs. This predictive approach allows the data platform to avoid the static planning limitations of traditional systems, resulting in more efficient resource use.

The data platform also improves on traditional task scheduling by identifying non-essential, non-sensitive workloads (like internal testing, automated builds, or reporting) that can be deferred or precomputed. Using demand forecasts, the data platform schedules these tasks during off-peak times, either before or after high-demand periods. By shifting non-urgent tasks away from peak usage hours, the data platform maximizes the availability of resources for client-critical operations and reduces the risk of resource constraints during high-demand times. This approach not only enhances resource utilization but also minimizes interruptions for high-priority client workloads.

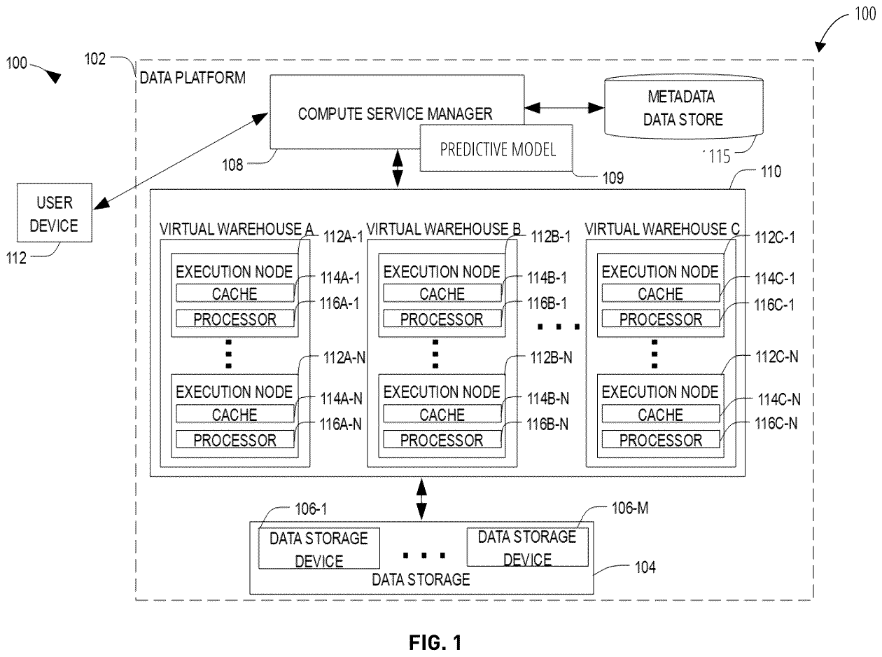

FIG. 1 illustrates an example computing environment 100 that includes a cloud data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the cloud data platform 102 comprises a three-tier architecture: a compute service manager 108 coupled to a metadata data store 115, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

As shown, the compute service manager 108 includes a predictive model 109 that is responsible for forecasting resource demand and optimizing resource commitments based on anticipated usage patterns. Further details of the operation of the predictive model 109 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B-1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 115 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 115, execution platform 110, and data storage 104 are shown in FIG. 1 as individual discrete components. However, each of the compute service manager 108, metadata data store 115, execution platform 110, and data storage 104 may be implemented as a distributed system (e.g., distributed across multiple systems/platforms at multiple geographic locations). Additionally, each of the compute service manager 108, metadata data store 115, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

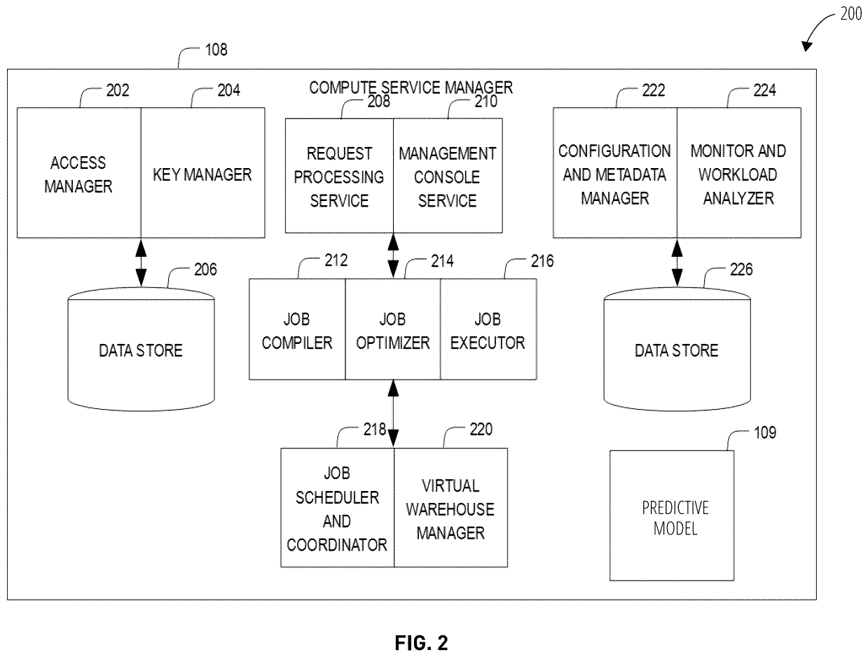

FIG. 2 is a block diagram 200 illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, the metadata data store 115, or any other storage device or system.

In addition, as mentioned above, the compute service manager 108 includes a predictive model 109 that is responsible analyzing historical and projected data to optimize resource allocation and commitment levels dynamically. Furth21er details regarding the functionality of the predictive model 109 are discussed below.

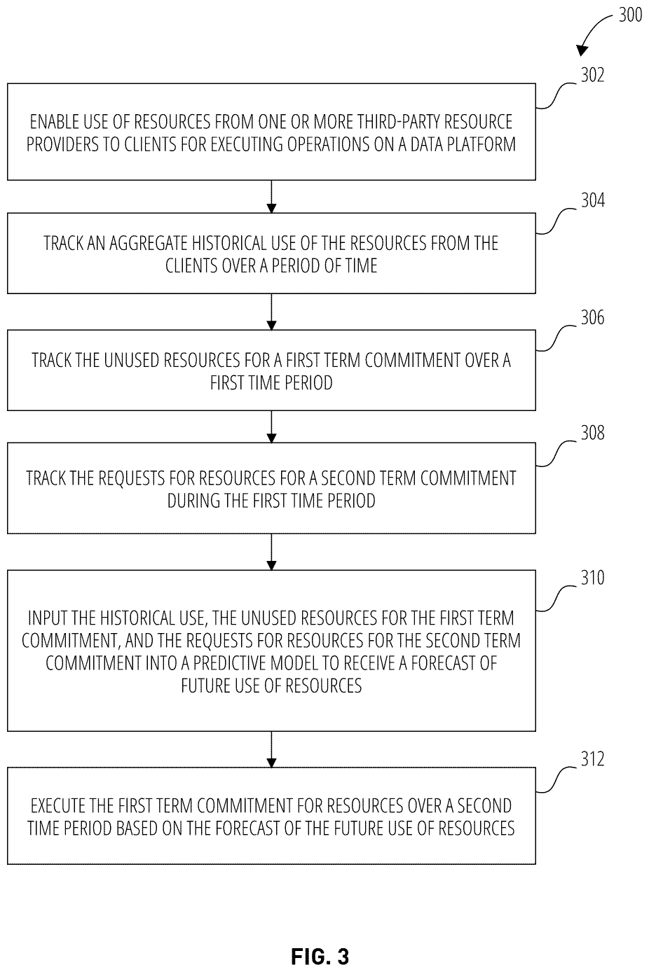

FIG. 3 illustrates an example method 300 for dynamically adjusting term commitments for resources, according to some examples. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

FIG. 3 is described as being performed by certain systems or applying certain processes, such as a particular predictive model or machine learning model, but the processes described herein can be performed by one or more other or the same predictive models or machine learning models.

At block 302, the data platform enables use of resources from one or more third-party resource providers to clients for executing operations on a data platform. The data platform can include a cloud-based system designed to enable clients (e.g., end-users or organizations) to perform various data-related operations such as data storage, processing, analysis, and retrieval.

These operations include tasks such as querying large datasets, running computations (e.g., machine learning models), generating reports, or other activities that require substantial compute power and storage capacity.

The platform itself may not own all or some of the physical infrastructure (e.g., servers, GPUs, or storage devices) but instead can leverage some or all of the resources provided by third-party resource providers. These third-party providers offer the physical and/or virtual infrastructure, such as compute resources and storage, which the data platform “rents” or “commits to” under various contractual terms.

At block 302, the data platform enables clients to access and use resources provided by these third-party providers. Clients interact with the data platform, such as through various APIs (Application Programming Interfaces) or user interfaces provided by the platform. The clients may request to perform operations such as running a complex query, storing large datasets, or deploying machine learning models. These operations can vary significantly in terms of their resource demands, with some tasks requiring high computational power (e.g., GPUs for machine learning) and others needing substantial storage capacity.

Upon receiving a request, the data platform allocates appropriate resources (compute, storage, etc.) from its pool of resources. Since at least some of these resources can be rented from third-party providers, the platform's internal systems manage which resources to allocate based on availability, cost efficiency, and the terms of the platform's contractual commitments.

The resource allocation involves determining the specific type and amount of resources needed (e.g., selecting a suitable virtual machine, GPU, or storage block) to meet the performance and cost needs of the client's operation. For instance, high-priority tasks might be assigned dedicated resources with faster compute power, while lower-priority or batch tasks may use more cost-effective resources.

After resources are allocated, the data platform enables the execution of the client's requested operations. This may include provisioning virtual instances (e.g., VMs or containers) that will execute the client's code or queries, connecting storage resources to the instances for data input/output, allowing seamless data processing, managing network configurations to enable secure data transfers between the platform, client, and any other necessary resources, and/or the like.

The platform coordinates these resources effectively so that client operations can execute without interruption and with the performance expected by the client. For example, when a client initiates a query, the data platform ensures that all necessary resources are provisioned and managed to optimize for speed, cost, and data integrity.

The data platform can operate in a multi-tenant environment where resources are shared among multiple clients. As demand fluctuates (e.g., peak hours vs. off-peak hours), the platform needs the ability to scale resources up or down based on client requirements and usage patterns.

In block 302, the data platform can execute scaling by dynamically provisioning additional resources from third-party providers when client demand spikes or reducing commitments during low usage periods.

For example, the data platform can commit to a first term commitment (e.g., long term one year commitment) over a first time period (e.g., from 2022-2023) of a certain amount of daily or monthly computation power. During periods of high demand, the platform may temporarily allocate extra compute instances to handle additional query load by committing to a second term commitment (e.g., short term one month or daily commitments) over a second time period (e.g., June of 2023). Conversely, during predictable low-demand periods (e.g., late at night or holidays), the platform may reduce its resource utilization, thereby lowering resource waste and optimizing efficiency.

The data platform may have contractual agreements with third-party providers that define the type and quantity of resources available, as well as the pricing structures (e.g., on-demand vs. reserved instances or savings plans). Long-term commitments generally provide better pricing but require accurate demand forecasting to avoid unnecessary resources.

At block 302, the data platform is not only enabling client usage of these resources but also strategically managing the resource mix to balance between long-term and short-term commitments. For example, based on expected demand, the platform might rely on long-term commitments (e.g., one-year contracts) for a base level of compute and storage, while supplementing with short-term resources (e.g., on-demand instances) during unexpected spikes.

The data platform can leverage a predictive model that forecasts resource needs and adjusts resource commitments accordingly, ensuring the platform can meet client demands while minimizing excess resource waste (as further described herein).

At block 304, the data platform tracks an aggregate historical use of the resources from the clients over a period of time. The historical data provides valuable insights into patterns and trends in resource demand, which are used later in the process to predict future usage and/or recommendations or executions of resource commitments.

The data platform can track historical usage by continuously monitoring and recording how clients use resources on the platform. Resources may include compute power, storage capacity, and other cloud services provided to clients by third-party providers. By building a historical dataset of resource usage, the data platform gains a foundation for understanding typical demand patterns and identifying any recurring trends or anomalies in usage.

The data platform can monitor client requests and resource allocation. The data platform continuously logs requests made by clients to utilize resources, whether it's a query, data retrieval, processing task, or storage request. Each logged event can include details such as the type of resource requested, the duration of use, and the amount of capacity used (e.g., memory, CPU cycles, storage space).

To accurately capture usage patterns, each resource usage event can be timestamped. This includes start and end times for each request, which allows the platform to analyze resource usage across specific periods. The data platform can use such timestamped data for identifying time-based trends, such as whether demand increases at certain times of the day or whether specific days of the week consistently show higher or lower usage.

In some cases, the data platform aggregates this usage data over defined time intervals (e.g., hourly, daily, weekly). Aggregation simplifies analysis by organizing data across clients into manageable units, which can then be used to identify larger trends. For example, weekly aggregations may reveal patterns in workweek usage versus weekends, while monthly aggregations could show seasonal trends.

Since the platform may offer various types of resources (e.g., different instance types, storage tiers, or network bandwidth), the data platform can categorize historical data based on the type of resource used. This ensures that the predictive model has insights into the demand for each specific resource category.

Categorization allows the platform to refine forecasts based on particular resource needs, such as distinguishing between CPU and GPU demand, or high-speed storage versus archival storage, or storage versus computational load.

In some cases, the platform monitors the volume and intensity of each resource's use. For instance, high-intensity operations, such as large-scale data analysis tasks, might place a heavy load on computing resources. Recording the intensity of resource usage helps identify high-demand clients or operations, which may influence how the platform allocates resources in future periods or tailors the predictive model to account for these demands.

In cloud computing, several distinct resource types are managed by cloud providers to meet the diverse needs of clients. Each type of resource—e.g., compute power, storage, networking, databases, machine learning accelerators—has unique demand characteristics and optimization considerations.

The data platform can track and optimize commitments for compute power, enabling clients to perform data processing tasks, run applications, or execute computations. This resource can be measured in terms of CPU or GPU hours.

The data platform can track the usage of compute power by monitoring how many instances (e.g., virtual machines or containers) are launched, their types, and how long they are active. Commitments for compute resources can vary; clients may benefit from long-term savings plans or reserved instances for stable, predictable workloads, while on-demand or spot instances may be used for short-term, bursty workloads.

The data platform can optimize compute power by balancing between these types, leveraging long-term commitments to lower resource waste for predictable, regular tasks and using flexible commitments (e.g., spot instances) for tasks that can be interrupted or scheduled during low-demand periods.

The data platform can track and optimize commitments for storage, enabling clients to store datasets, backups, and other essential files. Cloud storage can include different tiers, such as high-performance storage for frequently accessed data and archival storage for infrequently accessed files. Each tier has different resource structures, with archival storage generally costing less but having longer retrieval times. In some cases, the data platform tracks and/or optimizes commitments based on actual and/or desired file availability and/or reliability.

The data platform tracks storage usage by monitoring the volume of data stored and the frequency of access across different tiers. Optimization can involve aligning data with the appropriate storage tier (e.g., shifting infrequently accessed data to lower-cost archival storage) and balancing between long-term storage commitments (like a reserved storage capacity) and flexible storage (such as pay-as-you-go storage) to minimize resource waste while ensuring availability based on data access patterns using the models described herein.

The data platform can track and optimize commitments for networking resources, such as bandwidth and data transfer capacities that allow data to move between cloud resources, clients, and end-users. Networking resource waste can be significant, especially for applications with high data transfer rates or those that span multiple regions. The data platform tracks the volume of inbound and outbound data transfer, as well as the geographic distribution of data flow.

Optimization in networking commitments can include region-based data transfer plans or commitment-based bandwidth packages that offer discounted rates for predictable usage. For clients with consistent network traffic patterns, the platform may leverage long-term networking commitments, while others with fluctuating needs might use pay-as-you-go options. Efficient routing and scheduling of non-urgent data transfers during off-peak hours can also help optimize network usage and reduce resource wastes.

The data platform can track and optimize commitments for managed databases provided by cloud providers used for data storage, retrieval, and analysis. These databases can range from relational databases (e.g., MySQL, PostgreSQL) to NoSQL databases (e.g., MongoDB, DynamoDB).

The platform tracks usage metrics such as database query volumes, read/write operations, and storage consumption to manage capacity effectively. Commitments for databases can come with options for provisioned capacity (where a certain level of compute and storage is reserved) or serverless models (where billing is based on actual query or transaction volumes).

The data platform can optimize database commitments by scaling provisioned capacity up or down based on usage patterns and leveraging serverless options for workloads with irregular query demands, reducing resource wastes without sacrificing database performance.

The data platform can track and optimize commitments for Machine learning (ML) workloads that can require specialized resources like GPUs, TPUs, or FPGAs to accelerate complex computations. These accelerators are expensive, so optimizing their usage is crucial for resource waste management.

The data platform tracks metrics such as GPU hours, memory usage, and task types to determine when and how accelerators are utilized. For recurring ML tasks, long-term commitments (like reserved GPU instances) can significantly reduce resource wastes, while spot instances or on-demand options are more suitable for exploratory or ad hoc ML tasks. The platform may also strategically shift training tasks or other ML workflows to off-peak periods, optimizing for resource waste without impacting timelines.

The data platform can track and optimize commitments for containers and orchestration services (e.g., Kubernetes clusters) that allow applications to be deployed in isolated environments, which is crucial for managing microservices and complex workflows. The platform tracks usage metrics such as container uptime, CPU and memory allocations, and container deployment frequencies.

Commitments here may involve reserved container instances or flexible container-as-a-service plans for workloads that require high elasticity. By analyzing container usage patterns, the platform can adjust commitments based on predictable demand or leverage on-demand container services for bursty workloads. Scheduled scaling and auto-scaling policies also help optimize resource waste while ensuring service reliability.

The data platform can track and optimize commitments for serverless functions allowing clients to execute code without managing infrastructure, typically billed based on the execution time and memory used per function. The platform can track function invocations, memory use, and average execution duration to understand demand patterns.

Since serverless functions are inherently flexible and often used for event-driven or sporadic workloads, commitments can include pay-as-you-go, but the platform can optimize resource waste by grouping non-urgent function executions into off-peak windows when possible. Additionally, for high-volume or frequently executed functions, cost-effective package options might be available from the provider.

The data platform can track and optimize commitments for data warehousing services that support large-scale data analytics by providing storage and compute resources specifically for querying and reporting. The platform tracks data warehousing usage by monitoring query volumes, storage capacity, and compute hours used for analytics.

Long-term commitments, such as reserved instances for consistent query volumes, provide cost benefits for regular, ongoing analytical workloads. For irregular analysis tasks, the platform may use on-demand pricing or even defer batch analytics to periods with lower usage to balance resource demands and resource waste effectively.

The data platform can track and optimize commitments for Content Delivery Network (CDN) services by caching data at various points around the globe, reducing latency and improving user experience. CDN resources can be tracked based on data transfer volume, cache hits, and geographic distribution of requests.

Optimization in CDN commitments could involve regional data transfer plans and commitment-based pricing for high-traffic regions. By analyzing historical usage patterns, the platform can make region-specific commitments for predictable usage while using flexible options for less predictable regions, thus reducing data transfer costs.

The data platform can track and optimize commitments for backup and disaster recovery for data resilience and compliance. The platform tracks backup storage usage, frequency of data snapshots, and replication metrics across regions.

Cloud providers can offer backup storage plans with discounted rates for long-term commitments, which are suitable for predictable backup needs. For temporary or seasonal backups, pay-as-you-go models are preferable. The platform can optimize backup commitments by categorizing data based on criticality, ensuring that high-priority backups use committed storage, while other backups utilize flexible storage options as demand fluctuates.

The data platform can track and optimize commitments for security services (e.g., DDoS protection, vulnerability scanning, encryption key management) for safeguarding client data and ensuring regulatory compliance. The data platform tracks metrics like the number of security scans, protection hours, and encryption key usage.

Commitment options for security services may involve fixed-rate plans for ongoing protection services or per-usage billing for less frequent activities like vulnerability scans. The platform can optimize costs by committing to continuous services for critical security tasks, while using on-demand or scheduled scans for other tasks that can be run during off-peak times.

The data platform can track and optimize commitments for logging and monitoring services that track application health, performance metrics, and system logs, essential for maintaining operational insight. These services can be billed based on data ingested or metrics monitored.

The platform tracks logging volume and monitoring frequencies to gauge usage. For applications that need continuous monitoring, subscription-based monitoring plans reduce resource waste, while usage-based pricing is suitable for less critical applications. Optimizing logging and monitoring commitments includes tailoring data retention policies and limiting data ingestion during low-impact periods, ensuring critical monitoring while minimizing unnecessary resource waste.

Although examples described herein are described for one type of resource, such as computational power, it is appreciated that the functions and features can be applied to other resource types as discussed herein.

At block 306, the data platform tracks the unused resources for a first term commitment over a first time period. The data platform monitors resources that were committed to but ultimately remained underutilized or entirely unused.

In one example, the platform has committed to a certain level of computational power over a one-year period. However, the actual usage may fall below this committed capacity at various times, resulting in wasted resources. By identifying and quantifying this waste, the platform can make adjustments to optimize future commitments, reduce unnecessary resource waste, and improve overall resource utilization.

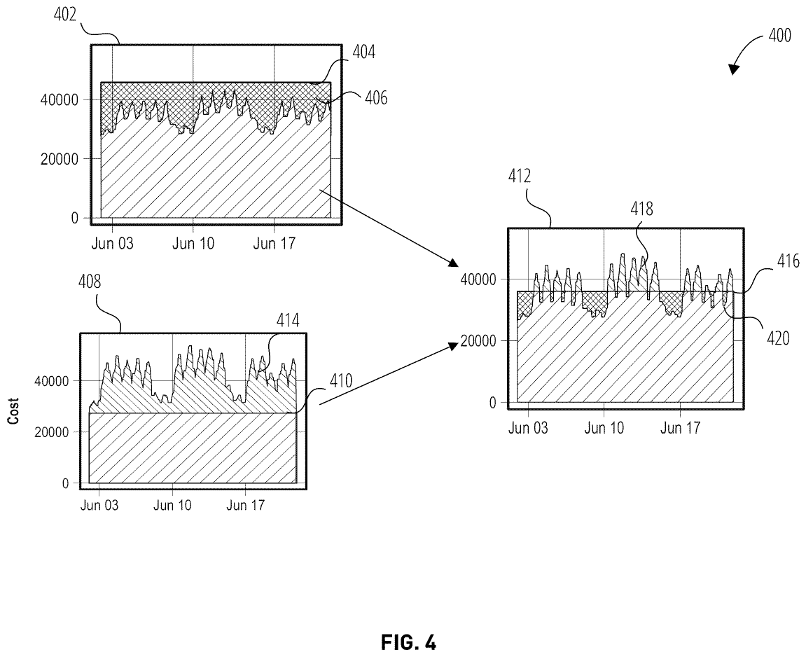

FIG. 4 is a set of graphs 400 illustrating the optimization process of resources, according to some examples. Graph 402 illustrates a commitment 404 that is set to the maximum amount of resources for the time period. As such, there are periods of time where the maximum amount of computational power is not used, and thus the unused commitments 406 are shown below the commitment line.

The first term commitment represents a contractual obligation between the data platform and the third-party resource provider to reserve a specified amount of computational power over a set period (in this case, one year).

This commitment is generally secured at a discounted rate, making it more cost-effective than on-demand resources. However, it also comes with rigid requirements: the platform must pay for the full committed capacity regardless of actual usage. If the demand for computational power falls short, the platform incurs costs for idle or underutilized resources.

To track unused resources, the data platform continuously monitors computational power usage throughout the commitment period. This can involve recording real-time data on the volume of resources used versus resources committed.

Each unit of computational power used—measured in metrics such as CPU hours, memory usage, or GPU hours—is logged and compared to the baseline of the committed capacity. For example, if the platform committed to 10,000 CPU hours per month, but actual demand fluctuates between 6,000 to 8,000 hours, the difference each month constitutes unused resources.

This real-time monitoring allows the platform to observe usage patterns that may change daily, weekly, or seasonally, identifying periods of underutilization within the larger term commitment.

The platform logs instances where the committed computational power exceeds the demand, labeling these as periods of underutilization or idle capacity. This unused capacity can be broken down further based on different timescales such as daily or weekly underutilization (e.g., weekends or specific off-peak hours might consistently show lower demand than the committed level), seasonal lulls (e.g., some industries have predictable seasonal downtimes such as retail's off-seasons, resulting in a drop in computational power usage), anomalies or unexpected dips where there may be irregular periods when demand unexpectedly dips due to factors like system updates, client maintenance periods, or external events, or the like. By categorizing these periods, the platform can identify recurring trends or specific times when unused capacity is most prevalent.

The data platform can quantify the extent of unused resources by calculating the difference between the committed resources and actual usage. For instance, if the platform committed to 10,000 CPU hours per month but used only 7,500 hours in a given month, the wasted capacity would be 2,500 hours.

Returning to FIG. 3, at block 308, the data platform tracks the requests for resources for a second term commitment during the first time period. The data platform tracks additional requests for resources that were required beyond the initial commitment level, (e.g., second term commitments), during the first time period.

The second term commitment becomes necessary when client demand exceeds the original first term resource commitment, prompting the platform to fulfill the excess demand using on-demand resources or other forms of short-term commitments. These additional resources, while more flexible, typically come at a higher cost and represent an important factor in managing overall efficiency and cost control.

The first term commitment represents the data platform's baseline level of resources committed for the time period, such as at a discounted rate due to a longer-term agreement (e.g., annual or multi-year commitments). This commitment is based on predicted demand patterns and covers typical or base usage levels. However, there are often periods when client demand spikes unexpectedly or seasonally, pushing the resource usage above this baseline commitment.

To handle these peaks, the data platform turns to second term commitments, which are additional, short-term resources—often in the form of on-demand or pay-as-you-go resources—to “top off” the capacity and meet the increased demand. These second term commitments are generally more costly but offer the flexibility to meet varying demand without the need for a long-term commitment.

These additional resources are usually billed at higher rates, so understanding the volume and cost of second term commitments is crucial for managing the overall budget as well as being able to provide sufficient resources to clients.

By tracking periods when demand exceeded the baseline, the platform gains insights into client usage patterns and can make more accurate predictions for future periods. Knowledge of peak demand patterns allows the data platform to adjust future baseline commitments, potentially reducing the need for costly on-demand resources. This tracking also helps the platform find an optimal balance between long-term, cost-effective commitments and short-term, flexible resources, ensuring resources are used efficiently without incurring excessive costs during demand spikes.

The data platform monitors real-time demand by analyzing and quantifying the cost impact of additional resource requests. The data platform continuously monitors real-time resource usage to identify when demand exceeds the committed baseline capacity (first term commitment), such as by tracking client requests for compute power and other resources against the committed threshold. As soon as usage levels approach or exceed this threshold, the platform records the need for second term commitments to satisfy the overflow demand.

When the demand surpasses the first term commitment, the platform can automatically or programmatically allocate additional resources to prevent service disruptions or delays in client operations. These resources can include on-demand instances (e.g., virtual machines or containers) provided by the third-party resource provider.

The first term commitment can represent a longer-term, pre-allocated resource commitment made by the data platform with a third-party provider. This commitment can be arranged well in advance of the actual usage period, based on forecasted demand and historical usage data.

For example, the first term commitment might span one year, allowing the platform to secure resources like compute power or storage capacity at discounted rates. The extended length of this commitment makes it a cost-effective option, as cloud providers generally offer reduced rates for clients willing to reserve resources over a substantial period. However, the trade-off is reduced flexibility: once committed, these resources must be paid for, whether or not they are fully utilized. As such, the first term commitment is optimized for stable, predictable demand patterns, covering the baseline resource needs expected over the long term.

In contrast, the second term commitment can include a shorter-term, flexible resource allocation made in response to real-time demand spikes that occur during the first time period. Unlike the first term commitment, which is pre-arranged, the second term commitment can be initiated dynamically as needed within the usage period—often to address unexpected or peak demands that exceed the baseline capacity.

These resources can be provided on a pay-as-you-go or on-demand basis, which, while more expensive than long-term commitments, allows the platform to scale capacity up temporarily without committing to an extended term. For example, if client demand unexpectedly increases in specific months, the data platform uses the second term commitment to “top off” resources for those peak periods.

This shorter-term, flexible commitment is ideal for handling variability in demand, ensuring that client needs are met promptly without over-committing to resources in the long run.

Returning to FIG. 4, graph 408 illustrates a commitment 410 where the commitment level is set at the minimum amount of computational power usage. As such, there are periods of time where the minimum amount of computational power is not sufficient, and thus the second term commitments 414 are shown above the commitment line where more computational power was requested.

At block 310, the data platform inputs the historical use, the unused resources for the first term commitment, and the requests for resources for the second term commitment into a predictive model to receive a forecast of future use of resources.

The data platform consolidates multiple data sources—historical resource usage, unused resources from the first term commitment, and requests for additional resources under the second term commitment—and inputs this information into a predictive model. The model generates a forecast of future resource usage.

By analyzing patterns and trends in past usage and adjusting for periods of underutilization or excess demand, the model aims to optimize future resource commitments, balancing resource waste effectiveness with the flexibility to handle varying demand.

The historical use of resources provides the foundation for understanding typical client demand patterns. This data includes records of how clients have used resources (e.g., compute power, storage, networking) over previous time periods. Historical usage data captures time-based trends, such as daily, weekly, or seasonal demand cycles, and may show usage spikes during specific times of the year (e.g., year-end for retail clients or tax season for financial clients).

This input gives the predictive model a baseline understanding of expected demand, allowing it to identify standard usage levels and recurring trends. For instance, if certain months consistently show high demand, the model can adjust its forecast to reflect this. Additionally, the historical usage data helps distinguish between stable demand patterns and irregular, unpredictable events, which is crucial for optimizing future commitments.

The unused resources from the first term commitment indicate periods when the data platform committed to a certain capacity level but didn't fully utilize it. This underutilization reflects potential inefficiencies in resource allocation, as the platform incurred resource waste for resources that were not fully used.

By analyzing these instances of underutilization, the model identifies when and why demand fell below expected levels, such as weekends, holidays, or seasonal slowdowns. This data helps the model understand periods of low demand and adjust future commitments to avoid over-allocation and reduce unnecessary resource waste.

Additionally, the model can incorporate insights from unused resources to recommend right-sizing the baseline capacity in future commitments. For instance, if certain periods consistently show lower demand than anticipated, the model may suggest a reduced commitment level during those times or a more flexible, laddered approach to resource allocation.

The requests for additional resources under the second term commitment represent times when client demand exceeded the baseline capacity, requiring the platform to supplement with on-demand or pay-as-you-go resources. These requests indicate peaks in demand that the first term commitment alone could not cover. Tracking these requests allows the predictive model to recognize patterns in peak usage, both in terms of timing (e.g., specific months or quarters) and intensity (e.g., how much capacity was needed beyond the baseline).

By including this data, the model can better predict future periods of high demand and recommend appropriate adjustments to the baseline commitment to reduce dependency on expensive second term commitments. The goal is to reduce reliance on on-demand resources, thereby lowering overall need of on demand resources while ensuring sufficient capacity to handle peak demand.

The predictive model utilizes advanced statistical and/or machine learning techniques to identify patterns, correlations, and trends within the input data. This model's objective is to generate a forecast of future resource usage, accounting for both predictable and variable factors.

The model first processes the input data, identifying and extracting key patterns in resource usage. The model can apply a time series analysis to allow the model to detect recurring cycles, trends, and seasonal variations in demand.

By analyzing the relationship between historical usage, underutilized resources, and excess demand, the model can distinguish between steady-state usage and demand fluctuations. For example, the model might observe that historical data shows steady weekday demand with a dip on weekends, while unused capacity is most common during holidays or off-hours.

The predictive model is trained to forecast demand levels based on the historical data patterns, using machine learning algorithms. The model is trained on past patterns allowing it to learn the factors influencing demand, such as the day of the week, seasonal events, or industry-specific cycles.

The model continuously refines its predictions based on newly observed data. For example, as more historical data is gathered, the model's accuracy improves, allowing it to make increasingly reliable forecasts for future periods.

The output of the predictive model can include a detailed forecast of future resource usage over the specified period. This forecast includes insights on expected baseline demand, projected peaks, and potential low-demand periods, providing the data platform with a comprehensive view of future resource needs.

The forecast can allow the data platform to adjust its first term commitments more effectively, aligning baseline commitments with anticipated demand. If the model predicts that certain months will consistently have lower usage, the platform can reduce its long-term commitments for those periods, thereby minimizing waste.

Conversely, if the model identifies predictable peak periods, the platform might increase baseline commitments for those times to avoid over-reliance on costly second term resources. This approach ensures that baseline commitments are optimized to cover typical demand, balancing cost-effectiveness with reliability.

By accurately forecasting demand peaks, the model allows the platform to plan for additional capacity in advance, potentially securing more affordable resources through staggered or laddered commitments rather than expensive on-demand resources (as further described herein).

The platform can reduce the need for second term commitments by adjusting the first term commitment to better align with peak demand, thereby minimizing the use of flexible but higher-cost resources. In cases where on-demand resources are still necessary, the model's forecast allows the platform to anticipate and allocate these resources efficiently, ensuring they are used only when absolutely needed.

The predictive model can include a machine learning model specifically trained to process several key inputs that provide a comprehensive view of past resource utilization. These inputs can include one or more of: the historical use of the resource, which reveals overall trends in client demand; unused resources for the first term commitment, which indicates periods of over-commitment or underutilization; and requests for resources for the second term commitment, which highlights times when demand exceeded the baseline commitment, necessitating additional on-demand resources.

By training the model on these diverse inputs, the platform gains a nuanced understanding of usage patterns, both predictable and variable, enabling it to identify correlations between regular demand cycles, unused capacity, and demand spikes. This robust input structure allows the model to recognize recurring patterns, as well as detect anomalies or irregular demand trends, setting the foundation for accurate forecasting.

In some examples, the predictive model is trained to generate a recommendation for the second term commitment within the upcoming time period, allowing for flexible resource adjustments as needed. This recommendation focuses on times when demand is expected to exceed the first term commitment, suggesting specific instances where additional resources may be required.

For instance, the model might predict short-term spikes in demand for particular days or months, recommending on-demand or pay-as-you-go resources to meet these needs efficiently. By forecasting the likely scale and timing of these excess demands, the model allows the platform to secure additional resources proactively, helping to minimize disruptions and avoid overreliance on costly last-minute resource allocations. This recommendation for the second term commitment provides the flexibility needed to handle demand surges while keeping the overall costs of resource allocation optimized.

The predictive model can be a machine learning model trained to generate a recommendation for the first term commitment of resources for an upcoming period, referred to as the second time period. By analyzing the historical usage data alongside instances of unused resources, the model can suggest an optimized commitment level that more closely aligns with anticipated demand, reducing the likelihood of underutilized resources.

For example, if the historical data indicates consistent underutilization during certain months, the model may recommend a reduced commitment level for similar future periods. Conversely, if patterns show recurring demand peaks, the model might recommend a higher baseline to cover these needs without relying heavily on costly on-demand resources. This recommendation for the first term commitment ensures that the baseline capacity aligns with typical demand, balancing cost-effectiveness with sufficient resource availability to meet client needs.

At block 312, the data platform executes the first term commitment for resources over a second time period based on the forecast of the future use of resources. The data platform uses the forecast generated by the predictive model to determine and execute the first term commitment of resources for an upcoming period, referred to as the second time period.

This commitment represents a baseline allocation of resources that is secured in advance, such as over a longer term (e.g., monthly, quarterly, or annually). The forecast from the predictive model, which accounts for historical usage patterns, periods of underutilization, and previous peaks that required additional resources, provides a data-driven basis for this commitment level. By aligning the first term commitment with forecasted demand, the data platform aims to ensure a stable and cost-effective allocation of resources that can meet typical client needs without excessive unused capacity.

This pre-allocated baseline of resources enables the platform to lock in resources at an optimal level while reducing the needs of on-demand resources. The predictive model's forecast allows the data platform to tailor this first term commitment to reflect actual usage trends. For example, if the forecast suggests that demand will likely be higher during certain months, the platform can increase the baseline commitment accordingly.

Conversely, if periods of lower demand are expected, the platform can reduce the commitment level to avoid paying for resources that will not be fully utilized. This tailored approach ensures that the data platform is well-prepared to handle predictable, ongoing demand in a cost-efficient way, balancing the need for resource availability with cost management.

By executing this first term commitment based on forecasted needs, the data platform establishes a foundational level of resources that will be readily available throughout the second time period. This proactive allocation reduces the number of times for emergency or last-minute resource adjustments, allowing the platform to operate smoothly and predictably.

At the same time, the forecast-informed commitment level also minimizes the likelihood of resource waste, as the baseline has been carefully calibrated to match expected demand. This strategic execution of the first term commitment thus enhances operational efficiency, improves cost management, and ensures that clients receive reliable, uninterrupted access to the resources they need.

In some cases, during the second time period, client demand for resources rises beyond what was allocated in the first term commitment, the data platform will respond by executing a second term commitment to cover this increased need over a second time period.

The platform dynamically allocates additional, often on-demand resources to “top off” the baseline capacity established by the first term commitment whenever demand exceeds the forecasted or committed level. This second term commitment allows the platform to flexibly and quickly adjust to unexpected spikes in client demand, ensuring that operations can continue seamlessly without resource shortages.

In some examples, the data platform utilizes a combination of resources from both third-party resource providers and its own internal resources to serve client operations. When executing the first term commitment, which involves planning and securing baseline resource capacity for a future period, the platform takes into account not only the resources committed from external providers but also the availability of its internal resources.

By factoring in its internal capacity, the platform can optimize the level of external resources it needs to commit to, potentially reducing costs and improving efficiency. This blended approach ensures that the platform leverages all available resources to meet client demands effectively, adjusting its commitments based on both internal capabilities and external provisions.

Returning to FIG. 4, graph 412 illustrates an optimal commitment level 416 where the unused resource waste 420 and the on-demand resource requests 418 are balanced based on forecasted demand.

The predictive model is designed to optimize the first term commitment for a future period (the second time period) in a way that minimizes resource inefficiencies. Specifically, the model forecasts an ideal commitment level that is intended to reduce the likelihood of unused resources—instances where resources go underutilized, leading to waste—within that term.

Additionally, the model further adjusts the first term commitment to decrease the expected need for additional on-demand capacity. By setting the first term commitment at a level that closely matches anticipated demand, the model ensures that the platform will rely less on costly on-demand resources, as the baseline allocation is more accurately aligned with forecasted client needs. This dual focus on reducing both underutilized resources and reliance on on-demand capacity allows the platform to optimize costs and improve resource efficiency over the second time period. In some cases, features described herein are described as an on-demand capacity, spot capacity, and/or a short-term commitment to differentiate over long-term commitments. However, it is appreciated that the features described herein can be applied to each of short-term commitments, spot capacity, or on-demand capacity.

In some examples, the model actively monitors real-time usage and adjusts commitment levels and/or job specifications from customers to optimize resource allocation on the fly (e.g., requesting on-demand or spot instance capacity). For instance, if the model detects an unexpected spike in demand for a time period—the model can automatically (1) increase the commitment level for resources from third-party providers, (2) get additional on-demand or spot instance capacity to cover the spike in demand, or (2) automatically load-shed or timeshift/defer the running of other workloads to reduce demand. This adjustment may involve temporarily scaling up on-demand resources to prevent service interruptions while balancing costs. Conversely, if the model observes that usage consistently drops below anticipated levels during certain time periods, it can dynamically lower commitments for those periods and/or reduce additional on-demand or spot capacity for those periods.

Alternatively, the model can be used to recommend optimal commitment levels for upcoming periods. The model analyzes historical usage data, underutilization patterns, and peak demand trends to forecast resource needs for specific future periods (e.g., weekly, monthly, quarterly or annually). Based on this analysis, the model provides commitment level recommendations to the platform, which may involve setting a higher baseline for known peak periods or reducing the baseline for off-peak seasons. For example, the model might recommend a higher commitment level for CPU resources during Q4 due to expected increases in client demand, while suggesting a lower commitment during Q2, which historically shows lower usage.

Systems and methods described herein include training a machine learning network, such as training to forecast a resource requirement, unused resources, resource requests, etc. The machine learning network can be trained to forecast such factors based on historical data of resource usage. The machine learning algorithm can be trained using historical information that include historical resource usage, and resulting unused resources and/or requests for additional resources.

Training of models, such as artificial intelligence models, is necessarily rooted in computer technology, and improves modeling technology by using training data to train such models and thereafter applying the models to new inputs to make inferences on the new inputs. Here, the new inputs can be resource usage of a past time period.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models. Such training is the framework of machine learning algorithms that enable the models to be applied to new and unseen data (such as new resource usage data) and make predictions that the model was trained for based on the weights or scores that were adjusted during training. Such training of the machine learning models described herein reduces false positives and increases the performance.

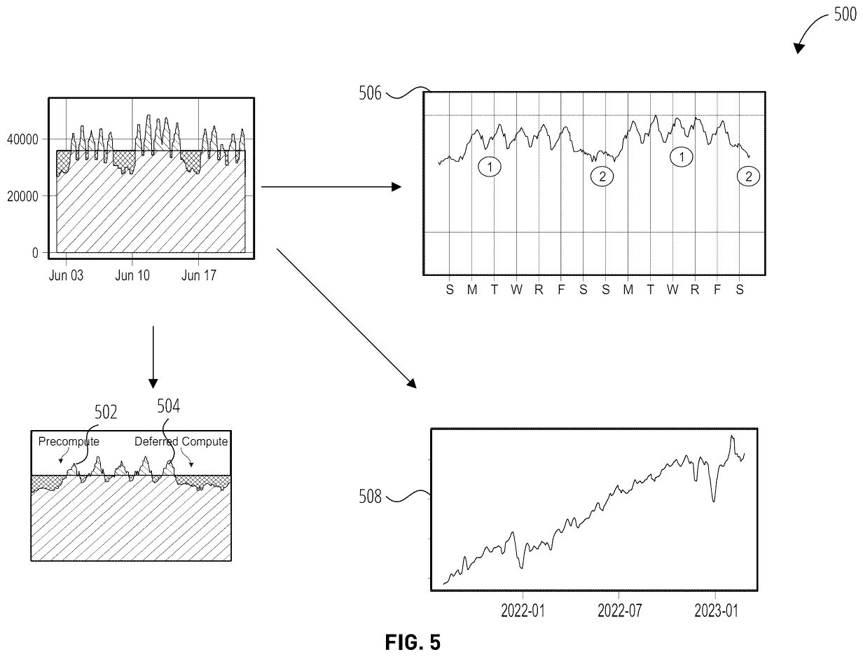

FIG. 5 illustrates further optimization of resource usage 500 according to some examples. Once the commitment level is set for the year, the data platform can utilize this predetermined resource capacity to further optimize task scheduling.

By analyzing forecasted resource needs, the platform identifies certain tasks that are non-sensitive—meaning they do not require immediate execution—and strategically schedules them during periods of low demand. This approach, involving either precomputation (executing tasks ahead of time) or deferred computation (delaying tasks until resources are less in demand), helps maximize resource utilization without impacting client-facing or time-sensitive operations.

Non-sensitive workloads can include internal tasks that do not affect immediate client operations or critical functions. These tasks can include regression testing (e.g., routine testing to ensure that recent code changes haven't introduced new bugs. These tests can be pre-scheduled or postponed, as they are generally not time-critical and can be run outside peak hours without impacting live services), automated builds (compiling code into executable forms for deployment. Since builds are only essential before deployment, the system can wait for low-demand periods to execute non-urgent builds, allowing the platform to keep resources available for high-priority client needs), internal reporting and analytics (e.g., generating reports on system performance, usage trends, or internal analytics for team reviews. These reports are typically used for internal insights rather than client-facing needs and can be generated during times of excess capacity), system maintenance and data backup (e.g., routine maintenance tasks such as backing up databases, rebalancing storage, or refreshing data indexes), and/or the like. By categorizing these tasks as non-sensitive, the system can flexibly schedule them around forecasted client demand, shifting them away from peak times.

The system can manage these non-sensitive workloads in two main ways—precompute and deferred compute—based on resource availability and forecasted needs. When the system anticipates a high demand period approaching (such as Q4 for retail, weekdays or tax season for finance), the system can precompute non-sensitive tasks during off-peak periods. For example, if the platform knows it will need to perform large-scale data analysis at the end of each quarter, the platform can run certain preliminary computations in advance during quieter times (e.g., early in the quarter or weekends).

By precomputing, the system reduces the computational load during the forecasted high-demand period, freeing up resources for critical client operations. This strategy is particularly beneficial for tasks like data indexing, where preprocessed data can be stored and quickly accessed when needed, without having to run the full computation in real time.

During high-demand periods, the platform may choose to delay certain non-urgent tasks, scheduling them to run later when demand is expected to drop. For example, if the platform experiences a spike in client demand during weekdays, it can defer automated testing or internal reporting tasks to nights or weekends, when demand is lower.

Deferred compute allows the platform to prioritize immediate client needs, ensuring that non-critical tasks do not consume resources needed for high-priority operations. This approach helps the platform manage resource constraints dynamically, adapting to current client demand without sacrificing internal task quality or coverage.

For example, the system runs nightly automated builds to compile the latest code changes. On nights when the forecast predicts lower client activity (e.g., early in the week), the system can schedule these builds to run later in the evening, when demand is low. This prevents the builds from competing with client-facing operations during busier hours.

As another example, if the platform expects high demand during weekdays, the platform may defer certain regression tests to run over the weekend. Since these tests are internal and can be delayed without immediate impact, shifting them to the weekend optimizes resource use, leaving more capacity available for client needs during peak periods.

As shown in FIG. 5, certain tasks that would have created a resource demand above the commitment level are precomputed 502 or the computation is deferred 504 to a forecasted time where the demand is expected to be less.

A machine learning model can be highly effective in managing task scheduling by forecasting resource demand and identifying optimal times to execute non-essential tasks. In the scenario described in FIG. 5, the model enables the platform to strategically precompute certain tasks (execute them in advance) or defer tasks (delay them to a later time) to avoid exceeding the resource commitment level.

The machine learning model analyzes historical usage data to predict future demand patterns. By using past data on client requests and resource usage trends, the model can detect patterns in high and low-demand periods, such as daily peaks, weekly cycles, or seasonal fluctuations. For example, the model might recognize that demand peaks during certain hours (e.g., weekday mornings) and dips during others (e.g., late nights or weekends).

Once trained, the model can forecast demand levels for upcoming periods, providing a clear picture of when resource demand will likely exceed or stay below the committed level. This forecast forms the basis for deciding whether to precompute or defer tasks, ensuring that tasks are strategically scheduled around these predicted demand levels.

Using the demand forecast, the machine learning model can identify low-demand windows where committed resources are expected to be underutilized. The model flags these periods as opportunities for precomputing tasks—executing them ahead of time to take advantage of available capacity. For instance, if a forecast indicates that weekend nights consistently have low demand, the platform could precompute tasks that would otherwise contribute to high demand during peak times, such as batch data processing or report generation. By running these tasks during off-peak hours, the platform maximizes resource utilization without impacting client operations during high-demand periods.

In this precompute approach, the model acts as a proactive scheduler by identifying tasks that can be executed in advance, optimizing the usage of committed resources and reducing the risk of needing additional on-demand resources. This results in better cost efficiency and more even resource utilization throughout the commitment period.

For tasks that are non-urgent and can be delayed without impacting functionality, the model can recommend deferring these tasks until a forecasted low-demand period. The model detects when demand is likely to exceed the commitment level and flags tasks that can be deferred to avoid overloading resources during these high-demand times.

By strategically postponing certain tasks—such as internal regression tests, system maintenance, or data backups—the platform can prioritize essential, time-sensitive client tasks while keeping overall demand below the committed threshold.

The model essentially enables adaptive scheduling by balancing tasks between high- and low-demand periods. This deferred approach ensures that resource availability is optimized for critical needs and prevents non-essential tasks from crowding out capacity during peak demand. For example, if a forecast indicates a weekday morning spike, the platform could defer automated builds or non-critical data processing tasks to run later in the day or overnight.

After the first term commitment for the second time period is executed, a machine learning model can be used to further optimize task scheduling within that period. Specifically, the model identifies tasks that were initially scheduled to run during times when resource availability exceeds the first term commitment—indicating potential periods of high demand—and reschedules them to other times within the same second time period when resource usage is forecasted to be below the first term commitment.

The model does this by either precomputing these tasks in advance (executing them earlier than planned) or deferring their execution to a later, less busy time. This proactive scheduling adjustment helps balance resource utilization across the time period, ensuring that committed resources are used more efficiently and that peak periods are preserved for critical, real-time operations, ultimately reducing the need for costly on-demand resources during demand spikes.

The model identifies periods of high or low resource use by analyzing historical usage data to detect recurring patterns in client demand over time. Using time series analysis, the model can capture trends, such as increased activity on specific days of the week (e.g., higher usage on Mondays or lower usage on weekends) as shown in 506 of FIG. 5 or during certain times of the day (e.g., peak usage in the morning).

Additionally, by examining seasonal fluctuations over multiple years, the model can recognize broader patterns, such as elevated resource demand during particular seasons (like Q4 for retail due to holiday shopping) or industry-specific cycles (like tax season for financial services) as shown in 508 of FIG. 5. With these insights, the model can forecast when resource usage is likely to spike or dip, allowing it to recommend adjustments in task scheduling and resource allocation that align with expected demand levels.

The model can incorporate factors that may not be based on historical data by using known information about upcoming events, such as product launches, system upgrades, feature rollouts, or changes in cloud service requirements. These events are often planned in advance, allowing the model to account for their potential impact on resource needs.

For instance, a product launch may lead to a significant increase in user activity, prompting the model to anticipate higher demand for computational resources, storage, or network capacity, even if similar activity hasn't occurred in the past. Similarly, a system upgrade might streamline operations, reducing the need for certain servers or increasing system efficiency, allowing the platform to adjust resource commitments accordingly.

For adaptive warehouses or increased capacity commitments, the model might account for additional infrastructure already planned, which would make more resources available to meet projected demand. In cases of feature upgrades or changes in cloud service requirements, the model can adjust its predictions by understanding how these updates will likely affect user interaction patterns, server loads, or data processing needs.

By integrating these forward-looking, non-historical factors, the model can proactively adjust resource commitments and scheduling to meet anticipated changes in demand, optimizing resource allocation based on upcoming known activities rather than relying solely on past trends.

In some examples, the data platform ladders commitments by staggering resource commitments over different time frames to increase flexibility, optimize costs, and better match anticipated demand. Laddering can be applied to both long-term and short-term commitments to manage resources effectively, avoiding the risks associated with a single, fixed commitment level.

In long-term laddering, the platform makes staggered commitments that are set to expire or renew at different intervals. For example, instead of committing all resources for an entire year upfront, the platform might allocate 50% of its resources on an annual commitment, 30% on a six-month commitment, and 20% on a quarterly commitment. It is appreciated that other time periods can be applied.

This staggered approach enables the platform to reassess demand as each commitment term ends, allowing it to adjust resource levels more frequently based on updated forecasts and evolving client needs. As each commitment expires, the platform has the opportunity to increase, decrease, or shift resources based on demand patterns without being locked into a single, inflexible term for the entire year. Laddering long-term commitments in this way balances cost savings (from bulk or longer-term commitments) with flexibility to adapt as demand changes over time.

For short-term laddering, commitments are staggered within a smaller time frame, such as monthly, weekly, or even daily intervals. This approach is particularly useful for handling predictable fluctuations in demand without overcommitting. For instance, the platform may reserve a baseline capacity for an entire quarter but ladder additional, smaller commitments for specific high-demand months or days.

In a retail environment, the platform could ladder short-term commitments to ramp up capacity just before the holiday season, with each weekly commitment expiring at the end of peak shopping weeks. Short-term laddering allows the platform to top off resources as needed in response to shorter cycles or sudden demand spikes, enabling quick adjustments while avoiding the costs of continuously relying on expensive on-demand resources.

By using laddered commitments, the platform can achieve an effective blend of cost savings, flexibility, and responsiveness to demand changes across both long-and short-term horizons. This approach optimizes resource allocation by ensuring that commitments align more closely with actual usage patterns, helping to reduce wastage and improve operational efficiency.

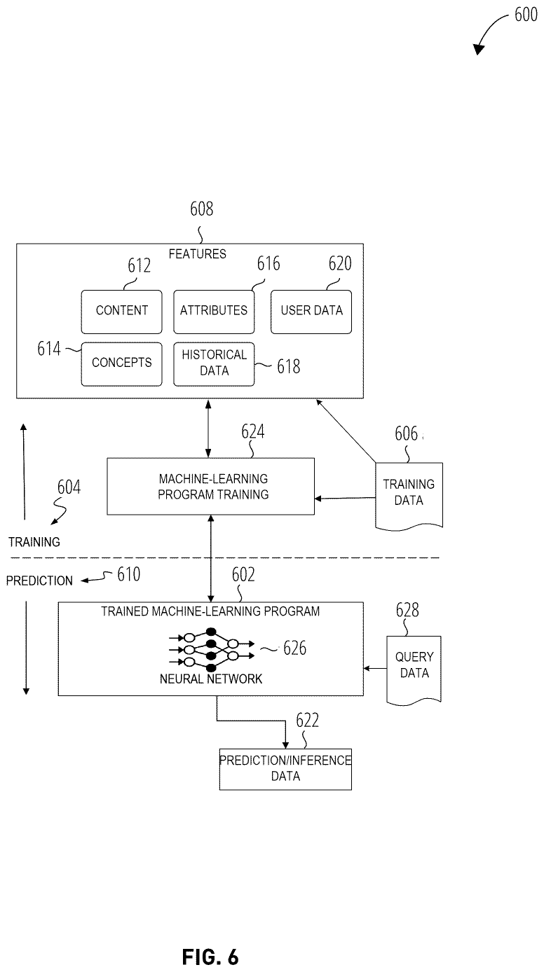

FIG. 6 illustrates further details of two example phases, namely a training phase 604 (e.g., part of the model selection and training 706) and a prediction phase 610 (part of prediction 710). Prior to the training phase 604, feature engineering 704 is used to identify features 608. This may include identifying informative, discriminating, and independent features for effectively operating the trained machine-learning program 602 in pattern recognition, classification, and regression. In some examples, the training data 606 includes labeled data, known for pre-identified features 608 and one or more outcomes. Each of the features 608 may be a variable or attribute, such as an individual measurable property of a process, article, system, or phenomenon represented by a data set (e.g., the training data 606). Features 608 may also be of different types, such as numeric features, strings, and graphs, and may include one or more of content 612, concepts 614, attributes 616, historical data 618, and/or user data 620, merely for example.

In training phase 604, the machine-learning pipeline 600 uses the training data 606 to find correlations among the features 608 that affect a predicted outcome or prediction/inference data 622.

With the training data 606 and the identified features 608, the trained machine-learning program 602 is trained during the training phase 604 during machine-learning program training 624. The machine-learning program training 624 appraises values of the features 608 as they correlate to the training data 606. The result of the training is the trained machine-learning program 602 (e.g., a trained or learned model).

Further, the training phase 604 may involve machine learning, in which the training data 606 is structured (e.g., labeled during preprocessing operations). The trained machine-learning program 602 implements a neural network 626 capable of performing, for example, classification and clustering operations. In other examples, the training phase 604 may involve deep learning, in which the training data 606 is unstructured, and the trained machine-learning program 602 implements a deep neural network 626 that can perform both feature extraction and classification/clustering operations.

In some examples, a neural network 626 may be generated during the training phase 604 and implemented within the trained machine-learning program 602. The neural network 626 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 626 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 626 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 604, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 610, the trained machine-learning program 602 uses the features 608 for analyzing query data 628 to generate inferences, outcomes, or predictions, as examples of a prediction/inference data 622. For example, during prediction phase 610, the trained machine-learning program 602 generates an output. Query data 628 is provided as an input to the trained machine-learning program 602, and the trained machine-learning program 602 generates the prediction/inference data 622 as output, responsive to receipt of the query data 628.

In some examples, the trained machine-learning program 602 may be a generative AI model. Generative AI is a term that may refer to any type of artificial intelligence that can create new content from training data 606. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like.

For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 622 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, eXtensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform 102 can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform 102 may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a cloud data platform 102, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

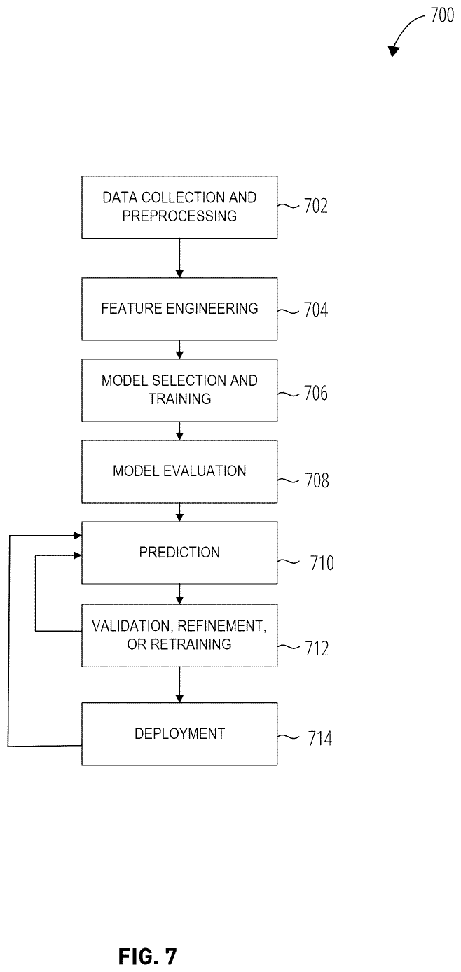

FIG. 7 depicts a machine-learning pipeline 700 and FIG. 7 illustrates training and use of a machine-learning program (e.g., model) 600. Specifically, FIG. 7 is a flowchart depicting a machine-learning pipeline 700, according to some examples. The machine-learning pipeline 700 can be used to generate a trained model, for example the trained machine-learning program 602 of FIG. 6, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 604 as described and depicted in connection with FIG. 7, generating a trained machine-learning program 602 may include multiple phases that form part of the machine-learning pipeline 700, including for example the following phases illustrated in FIG. 7: data collection and preprocessing 702, feature engineering 704, model selection and training 706, model evaluation 708, prediction 710, validation, refinement, or retraining 712, and deployment 714, or a combination thereof.

For example, data collection and preprocessing 702 can include a phase for acquiring and cleaning data to ensure that it is suitable for use in the machine learning model. This phase may also include removing duplicates, handling missing values, and converting data into a suitable format. Feature engineering 704 can include a phase for selecting and transforming the training data 606 to create features that are useful for predicting the target variable. Feature engineering may include (1) receiving features 608 (e.g., as structured or labeled data in supervised learning) and/or (2) identifying features 608 (e.g., unstructured, or unlabeled data for unsupervised learning) in training data 606. Model selection and training 706 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 708 can include a phase for evaluating the performance of a trained model (e.g., the trained machine-learning program 602) on a separate testing dataset. This phase can help determine if the model is overfitting or underfitting and determine whether the model is suitable for deployment. Prediction 710 can include a phase for using a trained model (e.g., trained machine-learning program 602) to generate predictions on new, unseen data. Validation, refinement or retraining 712 can include a phase for updating a model based on feedback generated from the prediction phase, such as new data or user feedback. Deployment 714 can include a phase for integrating the trained model (e.g., the trained machine-learning program 602) into a more extensive system or application, such as a web service, mobile app, or IoT device. This phase can involve setting up APIs, building a user interface, and ensuring that the model is scalable and can handle large volumes of data.

In view of the disclosure above, various examples are set forth below. It should be noted that one or more features of an example, taken in isolation or combination, should be considered within the disclosure of this application.

Example 1 is a computer system comprising: at least one hardware processor; and at least one memory storing instructions that cause the at least one hardware processor to perform operations comprising: enabling use of resources committed from one or more third-party resource providers to clients for executing operations on a data platform; tracking an aggregate historical use of the resources from the clients over a period of time; tracking unused resources for a first term commitment over a first time period; tracking requests for resources for a second term commitment during the first time period; inputting the historical use, the unused resources for the first term commitment, and the requests for resources for the second term commitment into a predictive model to receive a forecast of future use of resources; and executing the first term commitment for resources over a second time period based on the forecast of the future use of resources.

In Example 2, the subject matter of Example 1 includes, wherein the operations executed by the clients on the data platform comprises one or more of: querying data sets, performing computations, executing machine learning models, and generating reports.

In Example 3, the subject matter of Examples 1-2 includes, wherein the data platform enables a mix of use of the resources committed from the one or more third-party resource providers and resources internal to the data platform, wherein the execution of the first term commitment is further based on available resources internal to the data platform.

In Example 4, the subject matter of Examples 1-3 includes, wherein the data platform comprises a multi-tenant environment where the resources committed from the one or more third-party resource providers are shared among multiple clients for execution of individual operations on the data platform.

In Example 5, the subject matter of Examples 1-4 includes, wherein in response to an expected increase in the utilization of resources for executing the operations for the client that exceeds the resources committed in the first term commitment over the second time period, executing the second term commitment for resources during the second time period.

In Example 6, the subject matter of Examples 1-5 includes, wherein the first term commitment comprises an obligation between the data platform and at least a first third-party resource provider to reserve a specific amount of resource over the first time period.

In Example 7, the subject matter of Example 6 includes, wherein the first term commitment comprises a reservation of the specific amount of resource regardless of an actual usage by the clients of the data platform.

In Example 8, the subject matter of Examples 1-7 includes, wherein the requests for resources for the second term commitments were in response to resource requirements by the clients beyond a commitment level of the first term commitment.

In Example 9, the subject matter of Examples 1-8 includes, wherein the first term commitment is for a longer term than the second term commitment.

In Example 10, the subject matter of Examples 1-9 includes, wherein the first term commitment is a commitment made in advance of the first time period, whereas the second term commitment is made during the first time period.

In Example 11, the subject matter of Examples 1-10 includes, wherein the predictive model comprises a machine learning model trained to receive as input the historical use of the resource, the unused resources for the first term commitment, and the requests for resources for the second term commitment.

In Example 12, the subject matter of Examples 1 -11 includes, wherein the predictive model comprises a machine learning model trained to generate a recommendation for the first term commitment for resources of the second time period.

In Example 13, the subject matter of Examples 1-12 includes, wherein the predictive model comprises a machine learning model trained to generate a recommendation for a second term commitment for resources within the second time period.

In Example 14, the subject matter of Examples 1-13 includes, wherein the predictive model identifies the first term commitment for the second time period that reduces a forecast of unused resources for the first term commitment for the second time period.

In Example 15, the subject matter of Example 14 includes, wherein the predictive model identifies the first term commitment for the second time period further that further reduces the forecasted requests for resources for the second term commitment for the second time period.

In Example 16, the subject matter of Examples 1-15 includes, wherein the predictive model dynamically adjusts the first term commitments for the data platform.

In Example 17, the subject matter of Examples 1-16 includes, wherein the predictive model recommends the first term commitment for the data platform.

In Example 18, the subject matter of Examples 1-17 includes, wherein the operations further comprise, subsequent to executing the first term commitment for the second time period, executing a machine learning model that schedules tasks scheduled for time periods where an availability of the resource is above a commitment level of the first term commitment to another time period within the second time period where the resource availability is forecasted to be below the first term commitment by precomputing the tasks or deferring the execution time for the tasks.

Example 19 is a method performed by at least one hardware processor, the method comprising: enabling use of resources committed from one or more third-party resource providers to clients for executing operations on a data platform; tracking an aggregate historical use of the resources from the clients over a period of time; tracking unused resources for a first term commitment over a first time period; tracking requests for resources for a second term commitment during the first time period; inputting the historical use, the unused resources for the first term commitment, and the requests for resources for the second term commitment into a predictive model to receive a forecast of future use of resources; and executing the first term commitment for resources over a second time period based on the forecast of the future use of resources.

Example 20 is computer-storage media comprising instructions that, when executed by one or more processors of a machine, configure the machine to perform operations comprising: enabling use of resources committed from one or more third-party resource providers to clients for executing operations on a data platform; tracking an aggregate historical use of the resources from the clients over a period of time; tracking unused resources for a first term commitment over a first time period; tracking requests for resources for a second term commitment during the first time period; inputting the historical use, the unused resources for the first term commitment, and the requests for resources for the second term commitment into a predictive model to receive a forecast of future use of resources; and executing the first term commitment for resources over a second time period based on the forecast of the future use of resources.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

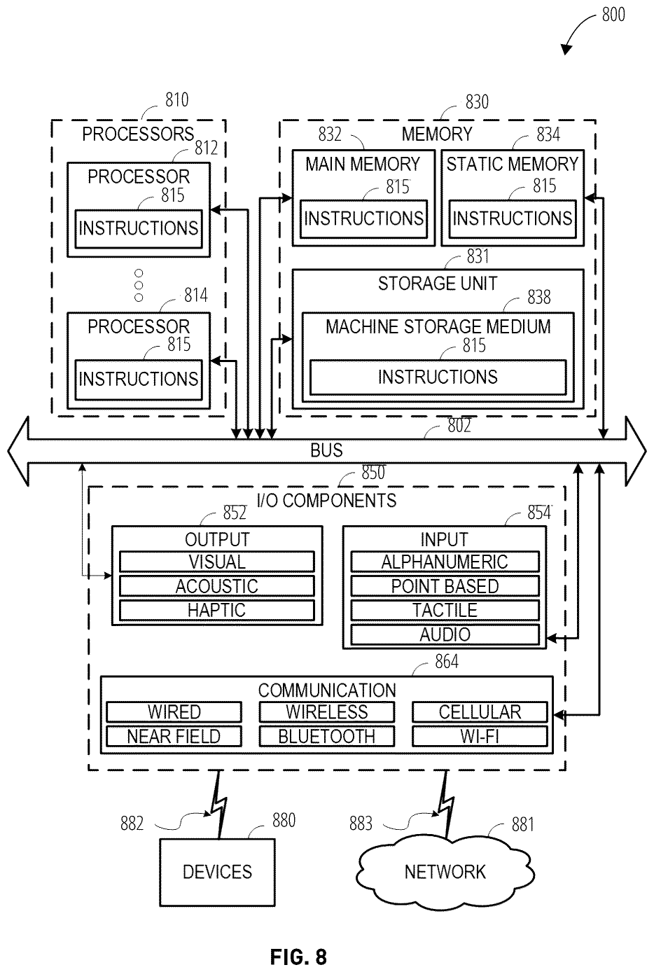

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 815 (e.g., software, a program, an application, an applet, an app, or other executable code), for causing the machine 800 to perform any one or more of the methodologies discussed herein, may be executed. For example, the instructions 815 may cause the machine 800 to implement portions of the data flows described herein (e.g., data flows described and depicted in FIG. 8). In this way, the instructions 815 transform a general, non-programmed machine into a particular machine 800 (e.g., the client device 112 of FIG. 1, the compute service manager 108 of FIG. 1, the execution platform 110 of FIG. 1) that is specially configured to carry out any one of the described and illustrated functions in the manner described herein.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 815, sequentially or otherwise, that specify actions to be taken by the machine 800. Further, while only a single machine 800 is illustrated, the term “machine” shall also be taken to include a collection of machines 800 that individually or jointly execute the instructions 815 to perform any one or more of the methodologies discussed herein.

The machine 800 includes processors 810 (such as processor 812 and processor 814), memory 830, and input/output (I/O) I/O components 850 (including output components 852 and input components 854) configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 815. The term “processor” is intended to include multi-core processors 810 that may comprise two or more independent processors (sometimes referred to as “cores”) that may execute instructions 815 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 831, all accessible to the processors 810 such as via the bus 802. The main memory 832, the static memory 834, and the storage unit 831 comprise a machine storage medium 838 that may store the instructions 815 embodying any one or more of the methodologies or functions described herein. The instructions 815 may also reside, completely or partially, within the main memory 832, within the static memory 834, within the storage unit 831, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines, such as mobile phones, will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine machine 800 to a network 881 via a coupler 883 or to devices 880 via a coupling 882. For example, the communication components 864 may include a network interface component or another suitable device to interface with the network 881. In further examples, the communication components 864 may include wired communication components, wireless communication components, cellular communication components, and other communication components to provide communication via other modalities. The devices 880 may be another machine or any of a wide variety of peripheral devices (e.g., a peripheral device coupled via a universal serial bus (USB)). For example, as noted above, the machine 800 may correspond to any one of the client device 112, the compute service manager 108, and the execution platform 110, and may include any other of these systems and devices.

The various memories (e.g., 830, 832, 834, and/or memory of the processor(s) 810 and/or the storage unit 831) may store one or more sets of instructions 815 and data structures (e.g., software), embodying or utilized by any one or more of the methodologies or functions described herein. These instructions 815, when executed by the processor(s) 810, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 881 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 881 or a portion of the network 881 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 815 may be transmitted or received over the network 881 using a transmission medium via a network interface device (e.g., a network interface component included in the communication components 864) and utilizing any one of a number of well-known transfer protocols (e.g., hypertext transfer protocol (HTTP)). Similarly, the instructions 815 may be transmitted or received using a transmission medium via the coupling 882 (e.g., a peer-to-peer coupling) to the devices 880. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 815 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A computer system comprising:
at least one hardware processor; and
at least one memory storing instructions that cause the at least one hardware processor to perform operations comprising:
enabling use of resources committed from one or more third-party resource providers to clients for executing operations on a data platform;
tracking an aggregate historical use of the resources from the clients over a period of time;
tracking unused resources for a first term commitment over a first time period;
tracking requests for resources for a second term commitment during the first time period;
inputting the historical use, the unused resources for the first term commitment, and the requests for resources for the second term commitment into a predictive model to receive a forecast of future use of resources; and
executing the first term commitment for resources over a second time period based on the forecast of the future use of resources.

2. The computer system of claim 1, wherein the data platform enables a mix of use of the resources committed from the one or more third-party resource providers and resources internal to the data platform, wherein the execution of the first term commitment is further based on available resources internal to the data platform.

3. The computer system of claim 1, wherein the data platform comprises a multi-tenant environment where the resources committed from the one or more third-party resource providers are shared among multiple clients for execution of individual operations on the data platform.

4. The computer system of claim 1, wherein in response to an expected increase in the utilization of resources for executing the operations for the client that exceeds the resources committed in the first term commitment over the second time period, executing the second term commitment for resources during the second time period.

5. The computer system of claim 1, wherein the first term commitment comprises an obligation between the data platform and at least a first third-party resource provider to reserve a specific amount of resource over the first time period.

6. The computer system of claim 5, wherein the first term commitment comprises a reservation of the specific amount of resource regardless of an actual usage by the clients of the data platform.

7. The computer system of claim 1, wherein the requests for resources for the second term commitments were in response to resource requirements by the clients beyond a commitment level of the first term commitment.

8. The computer system of claim 1, wherein the first term commitment is for a longer term than the second term commitment.

9. The computer system of claim 1, wherein the first term commitment is a commitment made in advance of the first time period, whereas the second term commitment is made during the first time period.

10. The computer system of claim 1, wherein the predictive model comprises a machine learning model trained to receive as input the historical use of the resource, the unused resources for the first term commitment, and the requests for resources for the second term commitment.

11. The computer system of claim 1, wherein the predictive model comprises a machine learning model trained to generate a recommendation for the first term commitment for resources of the second time period.

12. The computer system of claim 1, wherein the predictive model comprises a machine learning model trained to generate a recommendation for a second term commitment for resources within the second time period.

13. The computer system of claim 1, wherein the predictive model identifies the first term commitment for the second time period that reduces a forecast of unused resources for the first term commitment for the second time period.

14. The computer system of claim 13, wherein the predictive model identifies the first term commitment for the second time period that further reduces the forecasted requests for resources for the second term commitment for the second time period.

15. The computer system of claim 1, wherein the predictive model recommends the first term commitment for the data platform.

16. The computer system of claim 1, wherein the operations further comprise, subsequent to executing the first term commitment for the second time period, executing a machine learning model that schedules tasks scheduled for time periods where an availability of the resource is above a commitment level of the first term commitment to another time period within the second time period where the resource availability is forecasted to be below the first term commitment by precomputing the tasks or deferring the execution time for the tasks.

17. A method performed by at least one hardware processor, the method comprising:
enabling use of resources committed from one or more third-party resource providers to clients for executing operations on a data platform;
tracking an aggregate historical use of the resources from the clients over a period of time;
tracking unused resources for a first term commitment over a first time period;
tracking requests for resources for a second term commitment during the first time period;
inputting the historical use, the unused resources for the first term commitment, and the requests for resources for the second term commitment into a predictive model to receive a forecast of future use of resources; and
executing the first term commitment for resources over a second time period based on the forecast of the future use of resources.

18. The method of claim 17, wherein the data platform enables a mix of use of the resources committed from the one or more third-party resource providers and resources internal to the data platform, wherein the execution of the first term commitment is further based on available resources internal to the data platform.

19. The method of claim 17, wherein the data platform comprises a multi-tenant environment where the resources committed from the one or more third-party resource providers are shared among multiple clients for execution of individual operations on the data platform.

20. The method of claim 17, wherein in response to an expected increase in the utilization of resources for executing the operations for the client that exceeds the resources committed in the first term commitment over the second time period, executing the second term commitment for resources during the second time period.

21. The method of claim 17, wherein the first term commitment comprises an obligation between the data platform and at least a first third-party resource provider to reserve a specific amount of resource over the first time period.

22. The method of claim 21, wherein the first term commitment comprises a reservation of the specific amount of resource regardless of an actual usage by the clients of the data platform.

23. The method of claim 17, wherein the requests for resources for the second term commitments were in response to resource requirements by the clients beyond a commitment level of the first term commitment.

24. The method of claim 17, wherein the first term commitment is for a longer term than the second term commitment.

25. The method of claim 17, wherein the first term commitment is a commitment made in advance of the first time period, whereas the second term commitment is made during the first time period.

26. Computer-storage media comprising instructions that, when executed by one or more processors of a machine, configure the machine to perform operations comprising:
enabling use of resources committed from one or more third-party resource providers to clients for executing operations on a data platform;
tracking an aggregate historical use of the resources from the clients over a period of time;
tracking unused resources for a first term commitment over a first time period;
tracking requests for resources for a second term commitment during the first time period;
inputting the historical use, the unused resources for the first term commitment, and the requests for resources for the second term commitment into a predictive model to receive a forecast of future use of resources; and
executing the first term commitment for resources over a second time period based on the forecast of the future use of resources.

27. The computer-storage media of claim 26, wherein the data platform enables a mix of use of the resources committed from the one or more third-party resource providers and resources internal to the data platform, wherein the execution of the first term commitment is further based on available resources internal to the data platform.

28. The computer-storage media of claim 26, wherein the data platform comprises a multi-tenant environment where the resources committed from the one or more third-party resource providers are shared among multiple clients for execution of individual operations on the data platform.

29. The computer-storage media of claim 26, wherein in response to an expected increase in the utilization of resources for executing the operations for the client that exceeds the resources committed in the first term commitment over the second time period, executing the second term commitment for resources during the second time period.

30. The computer-storage media of claim 26, wherein the first term commitment comprises an obligation between the data platform and at least a first third-party resource provider to reserve a specific amount of resource over the first time period.
